(19) United States
(12) Patent Application Publication
(10) Pub. No.: US 2019/0007520 A1
(43) Pub. Date: Jan. 3, 2019

(54) ELECTRONIC DEVICE AND OPERATION METHOD THEREOF AND SERVER HOST DEVICE

(71) Applicant: Acer Incorporated, New Taipei City (TW)

(72) Inventor: Geng-Bao Lin, New Taipei City (TW)

(73) Assignee: Acer Incorporated, New Taipei City (TW)

(21) Appl. No.: 15/826,718

(22) Filed: Nov. 30, 2017

(30) Foreign Application Priority Data
Jun. 28, 2017 (TW) 106121578

(51) Int. Cl. H04L 29/08; H04L 12/26

(52) U.S. Cl. CPC H04L 67/32; H04L 43/0811; H04L 67/16

(57) ABSTRACT

An operation method of an electronic device is provided according to one embodiment. The electronic device includes an input interface, an output interface, a storage circuit and a network module, and the operation method includes: receiving an operation instruction through the input interface; generating a service request according to the operation instruction, wherein the service request includes service identification information; and if the network module is not connected to a network, extracting offline service information corresponding to the service identification information from the storage circuit, and presenting the offline service information through the output interface.

### CROSS-REFERENCE TO RELATED APPLICATION

This application claims the priority benefit of Taiwan application serial no. 106121578, filed on Jun. 28, 2017. The entirety of the above-mentioned patent application is hereby incorporated by reference herein and made a part of this specification.

### BACKGROUND OF THE INVENTION

### Field of the Invention

The invention relates to a computer technology, and particularly relates to an operation method, an electronic device and a server host device.

### Description of Related Art

Along with the increasing popularity of the Internet, more and more enterprises provide online customer services via the Internet, for example, an online voice customer service or an online text customer service. In this way, in addition to quick response to customer questions, phone call charges generated when customers call the customer service telephones are also saved. However, the online customer services transmit messages based on the Internet connection. Therefore, if a user device is not connected to the Internet, the user device cannot communicate with an enterprise end. Moreover, regarding most of the current smart phones or personal computers, if the devices cannot be connected to the Internet, a browser of the device can only display “the webpage cannot be displayed” or a similar message. In this case, the user has to wait for the device to successfully access the Internet or use other Internet-accessible device in order to obtain contact information of the related enterprise, so as to contact the related enterprise.

### SUMMARY OF THE INVENTION

The invention is directed to an operation method and an electronic device, which are adapted to provide offline service information corresponding to a specific service to a user in case that the device is not connected to the Internet.

The invention is also directed to a server host device, which is adapted to serve as an online storage and transfer platform for the offline service information, and/or serve as a service platform of an online interactive service.

An embodiment of the invention provides an operation method for an electronic device having an input interface, an output interface, a storage circuit and a network module, and the operation method includes: receiving an operation instruction through the input interface; generating a service request according to the operation instruction, where the service request includes service identification information; and if the network module is not connected to a network, extracting offline service information corresponding to the service identification information from the storage circuit, and presenting the offline service information through the output interface.

Another embodiment of the invention provides an electronic device including an input interface, an output interface, a storage circuit, a network module and a processor. The processor is coupled to the input interface, the output interface, the storage circuit and the network module. The processor is configured to receive an operation instruction through the input interface, and generate a service request according to the operation instruction, where the service request includes service identification information, and if the network module is not connected to a network, the processor is configured to extract offline service information corresponding to the service identification information from the storage circuit and present the offline service information through the output interface.

Another embodiment of the invention provides a server host device including a storage circuit, a network module and a processor. The storage circuit is configured to store offline service information. The network module is configured to connect to a network. The processor is coupled to the storage circuit and the network module. After a remote device is registered to the server host device, the processor receives the offline service information from the remote device through the network module. After an electronic device is connected to the server host device, the processor transmits the offline service information to the electronic device through the network module, where the offline service information includes an offline alternative plan of an online interactive service provided by the remote device.

According to the above descriptions, the operation method and the electronic device provided by the invention are adapted to receive the operation instruction input by the user through the input interface, and generate the service request including the service identification information. Particularly, if the electronic device is not connected to the network, the offline service information corresponding to the service identification information may be extracted from the storage circuit of the electronic device and presented by the output interface of the electronic device. In this way, even if the electronic device is currently not connected to the network, the user may also obtain the offline service information related to the required service. Moreover, the server host device provided by the invention may serve as a platform for transferring the offline service information.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a remote service system according to an embodiment of the invention.

FIG. 2 is a schematic diagram of an electronic device according to an embodiment of the invention.

FIG. 3 is a flowchart illustrating an operation method according to an embodiment of the invention.

FIG. 4 is a schematic diagram of the online interactive service according to an embodiment of the invention.

FIG. 5 is a schematic diagram of presented offline service information according to an embodiment of the invention.

FIG. 6 is a schematic diagram of presented predetermined offline information according to an embodiment of the invention.

### DESCRIPTION OF EMBODIMENTS

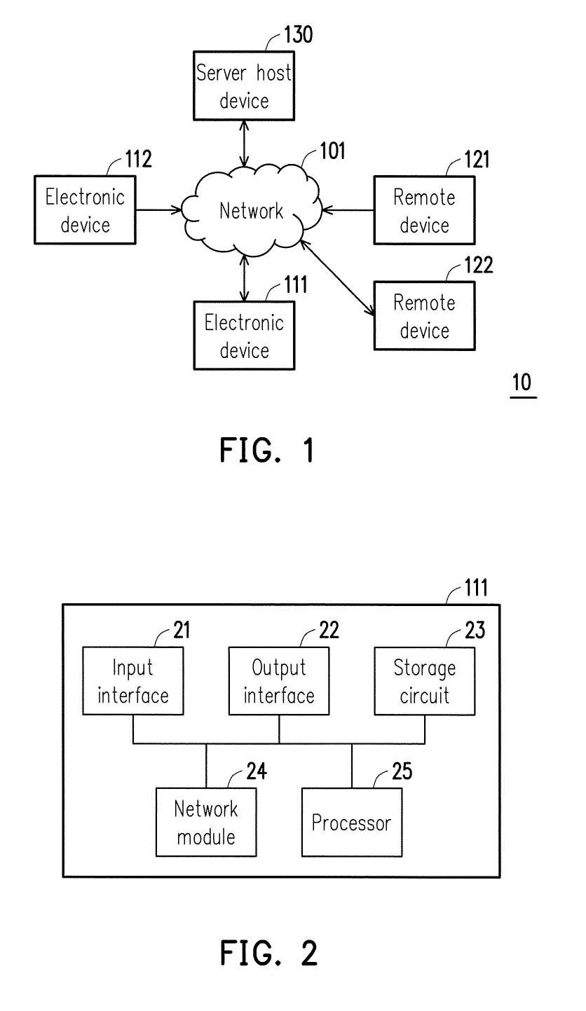

FIG. 1 is a schematic diagram of a remote service system according to an embodiment of the invention. Referring to FIG. 1, in an embodiment, the remote service system 10 includes a network 101, an electronic device 111 and a remote device 121. In an embodiment, the network 101 refers to the Internet. In another embodiment, the network 101 may refer to a local area network or a private network. The electronic device 111 and the remote device 121 may be respectively connected to the network 101 through a wired or wireless manner. Moreover, the electronic device 111 and the remote device 121 may be respectively an electronic device having a signal input function, a signal output function, a networking function and a computation function such as a smart phone, a tablet computer, a desktop computer or a notebook computer, etc.

In an embodiment, the electronic device 111 is a user device, and the remote device 121 is a device used for providing a client service (or customer service). For example, the remote device 121 may be a server host device of an enterprise A. If the remote device 121 is connected to the network 101, the remote device 121 may provide an entry webpage, an online contact window of the enterprise A or other enterprise information of the enterprise A (for example, merchandise information, a contact telephone number, an email address, or an enterprise registration address, etc.) for the user device to inquire and use. For example, if the electronic device 111 and the remote device 121 are both connected to the network 101, the electronic device 111 may browse or log on the entry webpage of the enterprise A to browse related enterprise information or leave a message. Alternatively, the electronic device 111 may also perform online communication with a customer service staff of the enterprise A through an online contact window provided by the remote device 121.

In an embodiment, if the electronic device 111 and the remote device 121 are both connected to the network 101, the electronic device 111 may download the enterprise information of the enterprise A from the remote device 121. Thereafter, if the user wants to use the electronic device 111 to browse the entry webpage of the enterprise A, to use the online contact window of the enterprise A or obtain the other enterprise information of the enterprise A, though the electronic device 111 is not connected to the network 101, the electronic device 111 may obtain the enterprise information of the enterprise A for presentation from the enterprise information downloaded in advance. For example, when the electronic device 111 is not connected to the network 101, the presented enterprise information of the enterprise A may include offline contact information (which is also referred to as offline service information) of the enterprise A such as the contact telephone number, the email address, or the enterprise registration address of the enterprise A. In this way, the user may change to call the contact telephone of the enterprise A to contact a telephone customer service staff of the enterprise A according to the offline service information, or directly go to the enterprise registration address to seek for service. Moreover, the offline service information of the enterprise A presented under the above offline state may further include other enterprise information, for example, merchandise information, etc., which is not limited by the invention.

FIG. 2 is a schematic diagram of an electronic device according to an embodiment of the invention. Referring to FIG. 2, the electronic device 111 includes an input interface 21, an output interface 22, a storage circuit 23, a network module 24 and a processor 25. The input interface 21, the output interface 22, the storage circuit 23 and the network module 24 are all coupled to the processor 25. The input interface 21 is used for receiving an operation instruction input by a user. For example, the input interface 21 may include a physical interface circuit used for inputting signals, such as a mouse, a keyboard, a touch panel or a microphone (i.e. a voice input device), etc. The output interface 22 is used for outputting singles. For example, the output interface 22 may include a physical interface circuit used for outputting signals, such as a screen (or a display), a projector or a loudspeaker (i.e. a voice output device), etc. In an embodiment, the input interface 21 and the output interface 22 may be combined into a touch screen or a device simultaneously having a signal input function and a signal output function. For example, the input interface 21 and the output interface 22 may be combined into a resistive touch panel, a capacitive touch panel, an optical touch panel, an acoustic touch panel or an electromagnetic touch panel, etc.

The storage circuit 23 is used for storing data in a non-volatile manner. Non-volatile data storage refers to that the data stored in the storage circuit 23 is not lost when power is stopped supplying to the storage circuit 23. For example, the storage circuit 23 may include a non-volatile storage medium such as a conventional hard disk drive (HDD), a solid state disk (SSD), a solid state hybrid drive (SSHD) or a flash memory, etc.

The network module 24 is used for connecting the electronic device 111 to the network 101 and transmitting message through the network 101. For example, the network module 24 may include a physical network interface circuit such as a wired and/or wireless network interface card, etc. For example, regarding the wireless communication, the network module 24 may support various wireless communication protocols, such as 3^{rd} generation wireless communication technology (3G), Bluetooth, general packet radio service (GPRS), high speed downlink packet access (HSUPA), high speed uplink packet access (HSUPA), wireless-fidelity (Wi-Fi), wireless wide area network (WWAN) and a long term evolution (LTE), etc. Moreover, regarding a wired network, the network module 24 may support a wired communication protocol such as Ethernet, etc.

The processor 25 is in charge of a whole operation of the electronic device 111. For example, the processor 25 may include a central processing unit (CPU), or other programmable general purpose or special purpose microprocessor, a digital signal processor (DSP), a controller, an application specific integrated circuit (ASIC), a programmable logic device (PLD) or other similar device or a combination of the above devices. Moreover, the processor 25 may be configured with a volatile storage medium such as a random access memory (RAM) or a read-only memory (ROM), etc.

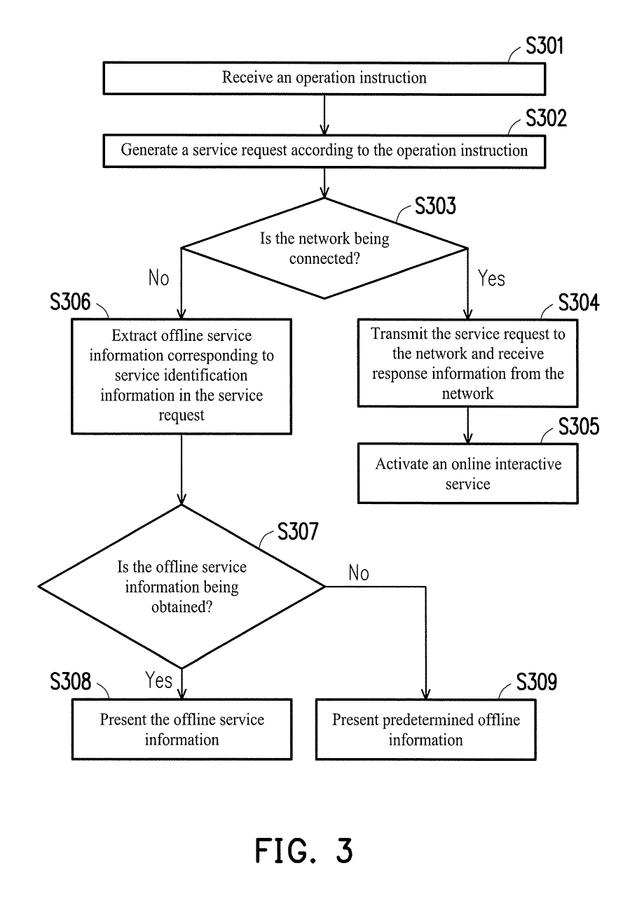

FIG. 3 is a flowchart illustrating an operation method according to an embodiment of the invention. The method of FIG. 3 is described below with reference of the embodiments of FIG. 1 and FIG. 2. Referring to FIG. 1 to FIG. 3, in step S301, the processor 25 receives an operation instruction through the input interface 21. For example, the operation instruction is generated based on user's operation performed on the input interface 21. In step S302, the processor 25 generates a service request according to the operation instruction, where the service request includes service identification information.

In an embodiment, the process 25 may execute a browser program (or a browser application). After the user selects a certain link (or shortcut) of the browser program or directly inputs a website address to the browser program through the input interface 21, the browser program may generate the service request. For example, the service request includes the website address, and the service identification information is included in the website address. For example, the service identification information may include at least one parameter and/or at least one fragment in the website address. For example, if it is assumed that one website address is “http://example.com/?org=A&id=2#swift”, the service identification information in the website address may include a parameter “org” with a value of “A”, a parameter “id” with a value of “2” and a fragment with a value of “swift”. In an embodiment, the website address is also referred to as a uniform resource locator (URL).

In step S303, the processor 25 determines whether the network module 24 is connected to the network 101. If the network module 24 is connected to the network 101, in step S304, the processor 25 transmits the service request to the network 101 through the network module 24 and receives a response message corresponding to the service request from the network 101. For example, after transmitting the service request to the network 101, the service request is routed and transmitted to the remote device 121. The remote device 121 replies the response message according to the service request. For example, the response message includes webpage composition information (for example, webpage codes) of an entry webpage and/or an online contact window of the enterprise A. Then, in step S305, the processor 25 activates the online interactive service. For example, the online interactive service may be executed by the browser program, for example, presented in a webpage manner. The user may communicate to the customer service staff of the enterprise A in text or voice through the online interactive service.

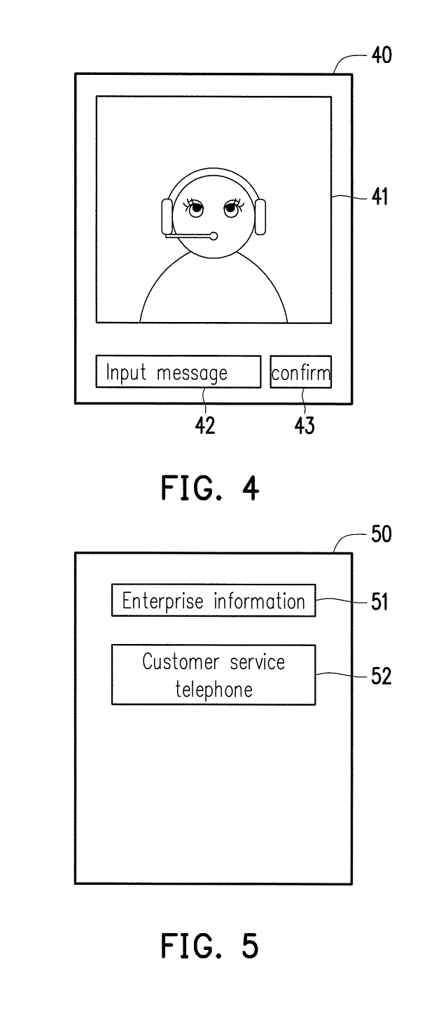

FIG. 4 is a schematic diagram of the online interactive service according to an embodiment of the invention. Referring to FIG. 4, in an embodiment, the browser program may display a webpage 40 according to the webpage composition information in the response message. The webpage 40 is an interactive webpage. For example, the webpage 40 may include a display window 41, a text input window 42 and a confirm button 43. The display window 41 may display a real-time image or a predetermined image of the remote customer service staff. The text input window 42 allows the user to input an instant message. After input of the instant message is completed, the user may click the confirm button 43 to send the instant message. Moreover, reply of the remote customer service staff may also be output in real-time through a voice manner, so as to implement interaction between the local user and the remote customer service staff.

It should be noted that the embodiment of FIG. 4 is merely an example of the online interactive service. In another embodiment, the user may also use a voice input manner to talk to the remote customer service staff, and/or the reply of the remote customer service staff may also be presented in the webpage 40 in a text manner, which is not limited by the invention. Moreover, a layout of the webpage 40 may also be changed based on an actual requirement, which is not limited by the invention.

Referring back to FIG. 3, in the step S303, if it is determined that the network module 24 is not connected to the network 101, a step S306 is executed. In the step S306, the processor 25 extracts offline service information corresponding to the service identification information from the storage circuit 23. For example, according to the service identification information (i.e. the parameter “org” with the value of “A”, the parameter “id” with the value of “2” and the fragment with the value of “swift”) in the aforementioned website address “http://example.com/?org=A&id=2#swift”, the processor 25 may extract the offline service information of the enterprise A from the storage circuit 23. In step S307, the processor 25 determines whether the required offline service information is obtained. If the required offline service information is obtained, in step S308, the processor 25 presents the extracted offline service information through the output interface 22. If the required offline service information cannot be obtained, in step S309, the processor 25 presents predetermined offline information through the output interface 22.

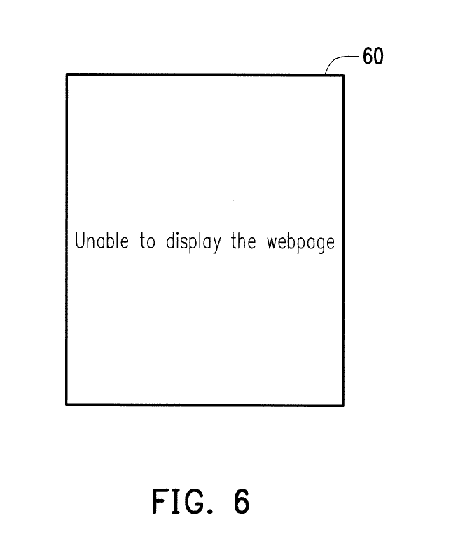

FIG. 5 is a schematic diagram of presented offline service information according to an embodiment of the invention. FIG. 6 is a schematic diagram of presented predetermined offline information according to an embodiment of the invention. Referring to FIG. 5, in an embodiment, the offline service information also includes webpage composition information. The browser program may display a webpage 50 according to the obtained offline service information. For example, the webpage 50 may present enterprise information 51 and a customer service telephone 52. For example, the enterprise information 51 may include merchandise information, a contact telephone number, an email address, or an enterprise registration address, etc. of the enterprise A. Moreover, the user may also call a local number or a mobile phone according to a telephone number shown in the customer service telephone 52, so as to try to contact the customer service staff of the enterprise A without using the network 101. Alternatively, according to another aspect, the offline service information may include an offline alternative plan corresponding to the online interactive service provided through the network 101.

Referring to FIG. 6, in an embodiment, the browser program may present the predetermined offline information through a page 60 (e.g. a webpage). For example, the page 60 may present any related prompt message of webpage reading failure caused by none Internet connection (or connection error) to the user, for example, “unable to display the webpage” or a similar message. It should be noted that the predetermined offline information is different to the offline service information. Compared to the offline service information extracted according to the service identification information, the predetermined offline information may be presented without using the service identification information. For example, in an embodiment, the predetermined offline information is preloaded to the browser program, and is not associated with any service identification information. Therefore, the predetermined offline information cannot be used for presenting the offline alternative plan of the online interactive service related to the enterprise A.

In an embodiment, a specific agent program (or client program) is installed in the storage circuit 23 in advance, and the processor 25 executes the agent program in order to execute the step S306 and the step S308. Therefore, in an embodiment, if the agent program is not installed in the electronic device 111 in advance, in the step S307, the processor 25 determines that the offline service information cannot be obtained, and the step S309 is executed. In an embodiment, the agent program is a “service worker” program, and the offline service information may be stored and managed through a user data storage plan “HTMLS offline storage” of the browser program. Moreover, in an embodiment, if the offline service information related to the currently used service identification information is not stored in the storage device 23 in advance, since the required offline service information cannot be obtained from the storage device 23, the determination result of the step S307 is negative (e.g., no), and the step S309 is then executed.

In an embodiment, it is assumed that the remote device 121 provides the online interactive service of the enterprise A, and the remote device 122 provides the online interactive service of an enterprise B. When the electronic device 111 is connected to the remote device 121 through the network 101, the electronic device 111 may execute the online interactive service provided by the enterprise A. When the electronic device 111 is connected to the remote device 122 through the network 101, the electronic device 111 may execute the online interactive service provided by the enterprise B. Moreover, the storage circuit 23 is stored with the offline service information of the enterprise A (which is also referred to as first offline service information) and the offline service information of the enterprise B (which is also referred to as second offline service information). For example, the offline service information of the enterprise A may include the offline alternative plan of the online interactive service of the enterprise A, and the offline service information of the enterprise B may include the offline alternative plan of the online interactive service of the enterprise B.

When the electronic device 111 is not connected to the network 101, the processor 25 may extract the offline service information of the enterprise A or the offline service information of the enterprise B from the storage circuit 23 according to the service identification information in the generated service request. For example, the processor 25 may inquire a table according to the currently used service identification information and determine to extract the offline service information of the enterprise A or the offline service information of the enterprise B according to an inquiring result. For example, the table may record first service identification information and second service identification information, where the first service identification information relates to the offline service information of the enterprise A, and the second service identification information relates to the offline service information of the enterprise B. When the currently used service identification information is matched to the first service identification information, the processor 25 extracts the offline service information of the enterprise A from the storage circuit 23. When the currently used service identification information is matched to the second service identification information, the processor 25 extracts the offline service information of the enterprise B from the storage circuit 23.

In an embodiment, if the network module 24 is connected to the network 101, the processor 25 may receive update information from the network 101 through the network module 24. For example, the update information may come from the remote device 121 or 122. If the update information comes from the remote device 121, the processor 25 may update the offline service information of the enterprise A stored in the storage circuit 23 according to the update information. If the update information comes from the remote device 122, the processor 25 may update the offline service information of the enterprise B stored in the storage circuit 23 according to the update information.

In an embodiment, the processor 25 (or the aforementioned agent program) may further generate an identification code, and store the identification code in the storage circuit 23. Alternatively, in an embodiment, when the electronic device 111 is connected to the remote device 121 through the network 101 (for the first time) or registers in the webpage provided by the remote device 121, the identification code may be assigned, by the remote device 121, to the electronic device 111 for usage. For example, the identification code may serve as a unique identification code for representing the electronic device 111. After the identification code is stored, the generated service request may further include the identification code. In this way, when the remote device 121 receives the service request from the electronic device 111, the remote device 121 may immediately learns that the currently connected device is the electronic device 111 according to the identification code carried by the service request, and the remote device 121 may record the connection information of the electronic device 111 or service content of the online interactive service executed this time to facilitate later customer maintenance and management.

In an embodiment, the electronic device 111 and the electronic device 112 may both be connected to the network 101 and may respectively select to perform the online interactive service with the remote device 121 or 122. A hardware configuration and an operation function of the electronic device 112 are the same or similar to a hardware configuration and an operation function of the electronic device 111, which is not repeated. In an embodiment, the electronic device 111 and the electronic device 112 may use different identification codes. According to the identification code carried by the service request, the remote device 121 may learn whether the device currently required for connection is the electronic device 111 or 112. Then, the remote device 121 may inquire the past interaction processes (e.g., interaction history) with the electronic device 111 or 112 according to the identification code of the electronic device 111 or 112, so as to improve service quality of the online interactive service of this time.

In an embodiment, the remote device 121 may also transmit the corresponding update information and/or advertising promotion information to the electronic devices 111 and 112 according to the identification codes of the electronic devices 111 and 112. The update information and/or advertising promotion information transmitted to the electronic devices 111 and 112 may be different according to different device types or operating system types. As a result, the offline service information stored in the electronic devices 111 and 112 corresponding to the same remote device 121 (or the enterprise A) may also be different.

In an embodiment, a server host device 130 is also connected to the network 101. The server host device 130 may be an industrial computer or a personal computer. The server host device 130 may serve as a service platform providing the aforementioned online interactive service (which is also referred to as an online interactive service platform). In an embodiment, the electronic device 111 may be connected to the server host device 130 through the network 101, and the electronic device 111 may execute the online interactive service of the remote device 121 through the server host device 130. For example, before using the online interactive service provided by the server host device 130, the electronic device 111 and the remote device 121 may register on the server host device 130. After the registration is completed, the electronic device 111 may transmit the aforementioned service request to the server host device 130 through the network 101, and the server host device 130 may create a connection between the electronic device 111 and the remote device 121 according to the service request (or the service identification information of the service request). Thereafter, the electronic device 111 and the remote device 121 may execute the online interaction based on the connection.

In an embodiment, the server host device 130 may also serve as a platform for providing updating and transferring of the offline service information. In an embodiment, the electronic device 111 may be connected to the server host device 130 through the network 101, and the electronic device 111 may store and update the offline service information of the remote device 121 and/or the remote device 122 through the server host device 130. For example, the remote device 121 and the remote device 122 may register on the server host device 130 and submit the respective offline service information to the server host device 130. For example, the submitted offline service information may be stored in a storage circuit of the server host device 130. Thereafter, when the electronic device 111 is connected to the server host device 130 through the network 101, the server host device 130 may transmit the offline service information submitted by the remote device 121 and the remote device 122 to the storage circuit 23 of the electronic device 111. Thereafter, when the electronic device 111 is not connected to the network 101, the processor 25 may inquire a table according to the currently used service identification information, and the processor 25 may determine to extract the offline service information of the enterprise A or the offline service information of the enterprise B according to the inquiring result.

It should be noted that the hardware structure of the server host device 130 may be the same or similar to the hardware structure of one of the electronic device 111, the electronic device 112, the remote device 121 and the remote device 122, such that the server host device 130 also has the functions of signal input, signal output, network connection, computation, etc. For example, a processor of the server host device 130 may be connected to the network 101 through a network module of the server host device 130 for transceiving data and executing the aforementioned operations. Moreover, the processor of the server host device 130 may also store data to the storage circuit of the server host device 130.

It should be noted that in the aforementioned embodiments, the browser program is taken as a main program for executing the online interactive service and presenting the offline service information on the user device. However, in another embodiment, along with different types of the user device or different enterprises for providing the online interactive service, the main program for executing the online interactive service and/or presenting the offline service information on the user device may also be other customized application other than the browser program. For example, the different enterprises may provide their exclusive applications for the user device to download and install. In this way, the user device may implement online interaction with the corresponding enterprise through the installed application, and may present corresponding offline service information in case of no network connection.

In summary, the operation method and the electronic device provided by the invention are adapted to receive the operation instruction input by the user through the input interface, and generate the service request including the service identification information. Particularly, when the current electronic device is not connected to the network, the offline service information corresponding to the service identification information may be obtained from the storage circuit of the electronic device and presented by the output interface of the electronic device. In this way, even if the electronic device is currently in a non-network-connection state, the user may also obtain the offline service information related to the required service. Moreover, corresponding to different service requests, the extracted offline service information may also be different, so as to provide the offline alternative plan that best meets the user's current needs. Moreover, the invention also provide a server host device, which may serve as an online storage and transfer platform for the offline service information, and/or serve as a service platform for providing the online interactive service.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An operation method, adapted to an electronic device having an input interface, an output interface, a storage circuit and a network module, and the operation method comprising:
receiving an operation instruction through the input interface;
generating a service request according to the operation instruction, wherein the service request comprises service identification information; and
extracting offline service information corresponding to the service identification information from the storage circuit and presenting the offline service information through the output interface if the network module is not connected to a network.

2. The operation method as claimed in claim 1, further comprising:
transmitting the service request to the network through the network module if the network module is connected to the network; and
receiving response information corresponding to the service request from the network through the network module and activating an online interactive service.

3. The operation method as claimed in claim 2, wherein the offline service information comprises an offline alternative plan corresponding to the online interactive service.

4. The operation method as claimed in claim 1, further comprising:
receiving update information from the network through the network module if the network module is connected to the network; and
updating the offline service information stored in the storage circuit according to the update information.

5. The operation method as claimed in claim 1, further comprising:
if the network module is not connected to the network and it is unable to extract the offline service information corresponding to the service identification information from the storage circuit, presenting predetermined offline information through the output interface, wherein the predetermined offline information is different to the offline service information.

6. The operation method as claimed in claim 1, wherein the step of presenting the offline service information through the output interface comprises:
presenting the offline service information through a browser program.

7. An electronic device, comprising:
an input interface;
an output interface;
a storage circuit;
a network module; and
a processor, coupled to the input interface, the output interface, the storage circuit and the network module, and the processor is configured to:
receive an operation instruction through the input interface;
generate a service request according to the operation instruction, wherein the service request comprises service identification information; and
if the network module is not connected to a network, extract offline service information corresponding to the service identification information from the storage circuit, and present the offline service information through the output interface.

8. The electronic device as claimed in claim 7, wherein the processor is further configured to:
if the network module is connected to the network, transmit the service request to the network through the network module; and
receive response information corresponding to the service request from the network through the network module, and activate an online interactive service.

9. The electronic device as claimed in claim 8, wherein the offline service information comprises an offline alternative plan corresponding to the online interactive service.

10. The electronic device as claimed in claim 7, wherein the processor is further configured to:
if the network module is connected to the network, receive update information from the network through the network module; and
update the offline service information stored in the storage circuit according to the update information.

11. The electronic device as claimed in claim 7, wherein the processor is further configured to:
if the network module is not connected to the network and it is unable to extract the offline service information corresponding to the service identification information from the storage circuit, present predetermined offline information through the output interface, wherein the predetermined offline information is different to the offline service information.

12. The electronic device as claimed in claim 7, wherein the output interface is configured to present the offline service information through a browser program.

13. A server host device, comprising:
a storage circuit, configured to store offline service information;
a network module, configured to connect a network; and
a processor, coupled to the storage circuit and the network module,
wherein the processor receives the offline service information from a remote device through the network module after the remote device is registered to the server host device, and
after an electronic device is connected to the server host device, the processor transmits the offline service information to the electronic device through the network module, wherein the offline service information comprises an offline alternative plan of an online interactive service provided by the remote device.
